(19) United States
(12) Patent Application Publication
(10) Pub. No.: US 2013/0286158 A1
(43) Pub. Date: Oct. 31, 2013

(54) DUAL-CHANNEL THREE-DIMENSION PROJECTOR

(71) Applicants: Chui-Fan CHIU, Taoyuan Hsien (TW); Harold BELLIS, Taoyuan Hsien (TW); Adam KUNZMAN, Taoyuan Hsien (TW); Kenneth BELL, Taoyuan Hsien (TW)

(72) Inventors: Chui-Fan CHIU, Taoyuan Hsien (TW); Harold BELLIS, Taoyuan Hsien (TW); Adam KUNZMAN, Taoyuan Hsien (TW); Kenneth BELL, Taoyuan Hsien (TW)

(73) Assignee: DELTA ELECTRONICS, INC., Taoyuan Hsien (TW)

(21) Appl. No.: 13/535,586

(22) Filed: Jun. 28, 2012

(30) Foreign Application Priority Data
Apr. 27, 2012 (TW) 101115016

(51) Int. Cl. H04N 13/00

(52) U.S. Cl. 348/43; 348/E13.062

(57) ABSTRACT

A dual-channel three-dimension projector is provided. The dual-channel three-dimension projector comprises a video processor, an FPGA, a first driver, a second driver and a digital micromirror device (DMD). The video processor receives a first video data via a first input interface and a second video data via a second input interface to generate a left-eye signal and a right-eye signal. The FPGA receives the left-eye signal and the right-eye signal via two paths respectively, and generates a left-image signal and a right-image signal. The first driver receives the left-image signal to generate a left-image control signal. The second driver receives the right-image signal to generate a right-image control signal. The DMD electrically connected to the first driver and the second driver alternately projects a left-eye image and a right-eye image according to the left-image control signal and the right-image control signal.

This application claims priority based on Taiwan Patent Application No. 101115016 filed on Apr. 27, 2012, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a dual-channel three-dimension projector; and more particularly, the dual-channel three-dimension projector of the present invention is a projector having two input interfaces and, through a dual-channel signal processing mechanism, projects a left-eye image and a right-eye image of a high resolution at a high image refresh rate.

2. Descriptions of the Related Art

In order to satisfy the demands for a high quality of life and entertainment in the modern society, requirements on fidelity and naturalness of images become heightened gradually. Correspondingly, technologies related to display devices are evolving from two-dimension (2D) displaying towards three-dimension (3D) displaying. Apart from the general image and color displaying effect, a 3D display device can further provide a stereoscopic displaying effect having a feeling of depth. With advancement of the technologies related to display devices, the demands for 3D projector technologies also become increasingly higher.

Because of the distance between two eyes of a person, there is an angular difference between images received by the left eye and the right eye. The images received are then processed in the brain so that a stereoscopic image is perceived by the person. According to the 3D projection technologies, a left-eye image signal and a right-eye image signal are inputted and processed by a 3D projector to generate images with a parallax which are then received by the left eye and the right eye respectively. That is, a feeling of a stereoscopic image is produced by simulating the way of naturally watching an object.

A conventional 3D projector receives a single input signal and utilizes the single input signal to project a left-eye image and a right-eye image so as to generate a 3D image. However, due to the limitation of the data amount of the single input signal, the left-eye image and the right-eye image can only be outputted at a low resolution or a low image refresh rate. The low resolution leads to degradation of the image quality, and the low image refresh rate leads to flickering of the image and insufficient brightness. Furthermore, for signals of the High Definition Multimedia Interface (HDMI) format, the conventional three-dimension projector is also unable to have the digital micromirror device (DMD) deliver its optimal performances to project the left-eye image and the right-eye image at a high image refresh rate.

Accordingly, an urgent need exists in the art to overcome the shortcomings of the conventional single-input projector that it has a low resolution or a low image refresh rate.

### SUMMARY OF THE INVENTION

An objective of the present invention is to provide a dual-channel three-dimension projector. The dual-channel projector of the present invention uses two input interfaces to receive video data and utilizes a dual-channel signal processing mechanism to project a left-eye image and a right-eye image of a high resolution at a high image refresh rate. Thereby, the present invention can overcome the problem of the conventional single-input projector that it has a low resolution or a low image refresh rate.

To achieve the aforesaid objective, the present invention discloses a dual-channel three-dimension projector, which comprises a video processor, a field-programmable gate array (FPGA), a first driver, a second driver and a digital micromirror device (DMD). The video processor has a first input interface and a second input interface. The first input interface is configured to receive a first video data. The second input interface is configured to receive a second video data. The video processor is configured to decode the first video data and the second video data to generate a left-eye signal and a right-eye signal. The FPGA is configured to receive the left-eye signal and the right-eye signal from the video processor via two paths respectively, and generate a left-image signal and a right-image signal according to the left-eye signal and the right-eye signal. The first driver is electrically connected to the FPGA, and configured to receive the left-image signal to generate a left-image control signal. The second driver is electrically connected to the FPGA, and configured to receive the right-image signal to generate a right-image control signal. The DMD is electrically connected to the first driver and the second driver, and configured to alternately project a left-eye image and a right-eye image according to the left-image control signal and the right-image control signal.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a dual-channel three-dimension projector according to a first embodiment and a second embodiment of the present invention; and

FIG. 2 is a schematic view of a dual-channel three-dimension projector according to a third embodiment of the present invention.

### DESCRIPTION OF THE PREFERRED EMBODIMENT

The present invention provides a dual-channel three-dimension projector. In the following descriptions, the present invention will be explained with reference to embodiments thereof. It shall be appreciated that, these embodiments are not intended to limit the present invention to any specific environments, applications or particular implementations described in these embodiments. Therefore, description of these embodiments is only for purpose of illustration rather than to limit the present invention, and the scope claimed in this application shall be governed by the claims. Additionally, in the following embodiments and the attached drawings, elements not directly related to the present invention are omitted from depiction; and dimensional relationships among individual elements in the attached drawings are illustrated only for ease of understanding but not to limit the actual scale.

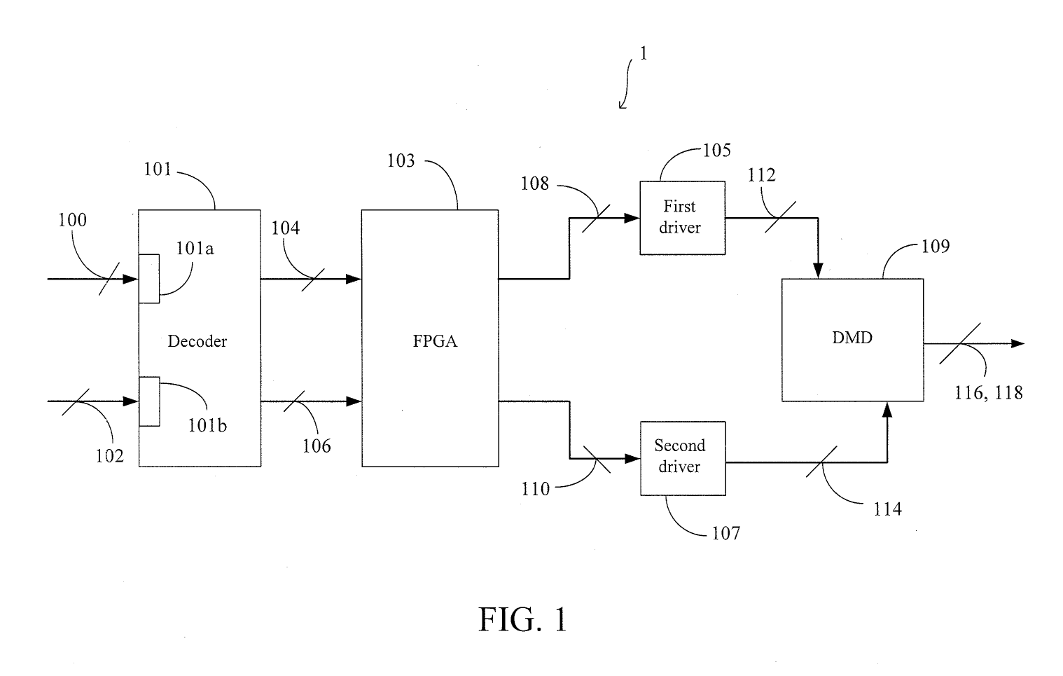

A first embodiment of the present invention is shown in FIG. 1, which is a schematic view of a dual-channel three-dimension projector 1. The dual-channel three-dimension projector 1 comprises a video processor 101, a field-programmable gate array (FPGA) 103, a first driver 105, a second driver 107 and a digital micromirror device (DMD) 109.

The video processor 101 is a chip (e.g., a Sigma GF 9452 chip, although it is not limited thereto) having two inputs and two outputs, and comprises a first input interface 101a and a second input interface 101b. The first input interface 101a is configured to receive a first video data 100, and the second input interface 101b is configured to receive a second video data 102. After the first video data 100 and the second video data 102 are received, the video processor 101 decodes the first video data 100 and the second video data 102 to generate a left-eye signal 104 and a right-eye signal 106.

The FPGA 103 receives the left-eye signal 104 and the right-eye signal 106 from the video processor 101 via two paths (i.e., two transmission lines) respectively (as shown in FIG. 1). Then, the FPGA 103 generates a left-image signal 108 and a right-image signal 110 according to the left-eye signal 104 and the right-eye signal 106. The first driver 105 and the second driver 107 are electrically connected to the FPGA 103 respectively. The first driver 105 is configured to receive the left-image signal 108 to generate a left-image control signal 112, and the second driver 107 is configured to receive the right-image signal 110 to generate a right-image control signal 114. In this embodiment, the first driver 105 and the second driver 107 may be but are not limited to DDP3021 chips from Texas Instruments (TI).

The DMD 109 is electrically connected to the first driver 105 and the second driver 107, and receives the left-image control signal 112 and the right-image control signal 114 from the first driver 105 and the second driver 107 respectively. Then, the DMD 109 projects a left-eye image 116 and a right-eye image 118 alternately in a time sequence according to the left-image control signal and the right-image control signal so that the left-eye image 116 and the right-eye image 118 are sequentially displayed on a display screen. Specifically, the DMD 109 has a plurality of micro minors which are arranged in an array. In the present invention, the minors of the DMD 109 are divided into a left-half part and a right-half part based on the overall projection image, with the mirrors of the left-half part being controlled by the first driver 105 and the mirrors of the right-half part being controlled by the second driver 107. In this way, the present invention can enable the DMD 109 to project the left-eye image 116 and the right-eye image 118 at a high image refresh rate.

In detail, the first video data 100 and the second video data 102 are generated by a multimedia generator (not shown) having two output interfaces. The multimedia generator may be a computer, a DVD player, a blue-ray player, or some other multimedia generator supporting output of HDMI format signals. In this embodiment, the first video data 100 is a left-eye video data, and the second video data 102 is a right-eye video data. Both the left-eye video data and the right-eye video data are an HDMI format signal. The left-eye video data has a data quantity with a resolution of 1080 p (1920×1080) and with 60 frames per second of the left-eye image, and the right-eye video data has a data quantity with a resolution of 1080 p and with 60 frames per second of the right-eye image. Accordingly, the left-eye signal 104 and the right-eye signal 106 generated by the video processor 101 through decoding also have a data quantity with a resolution of 1080 p and with 60 frames per second of the left-eye image and a data quantity with a resolution of 1080 p and with 60 frames per second of the right-eye image respectively.

After receiving the left-eye signal 104 and the right-eye signal 106 via the two paths respectively, the FPGA 103 retrieves a signal corresponding to the mirrors of the left-half part of the DMD 109 from the left-eye signal 104 and the right-eye signal 106 to generate the left-image signal 108, and retrieves a signal corresponding to the mirrors of the right-half part of the DMD 109 from the left-eye signal 104 and the right-eye signal 106 to generate the right-image signal 110. Then, the first driver 105 generates the left-image control signal 112 according to the left-image signal 108 to control the mirrors of the left-half part of the DMD 109, and the second driver 107 generates the right-image control signal 114 according to the right-image signal 110 to control the minors of the right-half part of the DMD 109. In this way, the DMD 109 can alternately project the left-eye image 116 and the right-eye image 118 of the resolution of 1080 p at an image refresh rate of 120 images per second. In other words, through the dual-channel processing mechanism of the present invention, the DMD 109 operates to project 120 images (including 60 left-eye images and 60 right-eye images) per second.

A second embodiment of the present invention is also shown in FIG. 1. Different from the first embodiment, the first video data 100 and the second video data 102 in this embodiment are identical to each other, and each comprise both the left-eye video data and the right-eye video data. Specifically, in the first video data 100 and the second video data 102, the left-eye video data has a data quantity with a resolution of 960×540 (half of 1080 p) and with 60 frames per second of the left-eye image and the right-eye video data has a data quantity with a resolution of 960×540 and with 60 frames per second of the right-eye image. Therefore, the video data inputted to the video processor 101 in this embodiment has only half of the data quantity of the first embodiment.

Because the left-eye video data and the right-eye video data comprised in the first video data 100 and the second video data 102 do not meet the requirement of the resolution of 1080 p, the video processor 101, after receiving the first video data 100 and the second video data 102, firstly separates the left-eye video data and the right-eye video data from each other, then interpolates the left-eye video data to generate the left-eye signal 104 with the resolution of 1080 p and interpolates the right-eye video data to generate the right-eye signal 106 with the resolution of 1080 p. Accordingly, upon completion of the interpolations, the left-eye signal will have a data quantity with the resolution of 1080 p and with 60 frames per second of the left-eye image, and the right-eye signal will have a data quantity with the resolution of 1080 p and with 60 frames per second of the right-eye image.

Next, as in the first embodiment, the FPGA 103 receives the left-eye signal 104 and the right-eye signal 106 via two paths respectively, and generates the left-image signal 108 and the right-image signal 110. Thus, the first driver 105 generates the left-image control signal 112 according to the left-image signal 108 to control the mirrors of the left-half part of the DMD 109, and the second driver 107 generates the right-image control signal 114 according to the right-image signal 110 to control the minors of the right-half part of the DMD 109. In this way, the DMD 109 can alternately project the left-eye image 116 and the right-eye image 118 of the resolution of 1080 p at an image refresh rate of 120 images per second.

It shall be appreciated that, the resolution of the left-eye video data and the right-eye video data comprised in the first video data 100 and the second video data 102 is not intended to limit the scope of the present invention. In other words, how a data quantity with the resolution of 1080 p is generated through interpolations in the present invention can be readily appreciated by those of ordinary skill in the art. Therefore, the technical contents of the present invention focus on how to enable the DMD 109 to alternately project the left-eye image 116 and the right-eye image 118 of the resolution of 1080 p at an image refresh rate of 120 images per second through the dual-channel processing mechanism of the present invention.

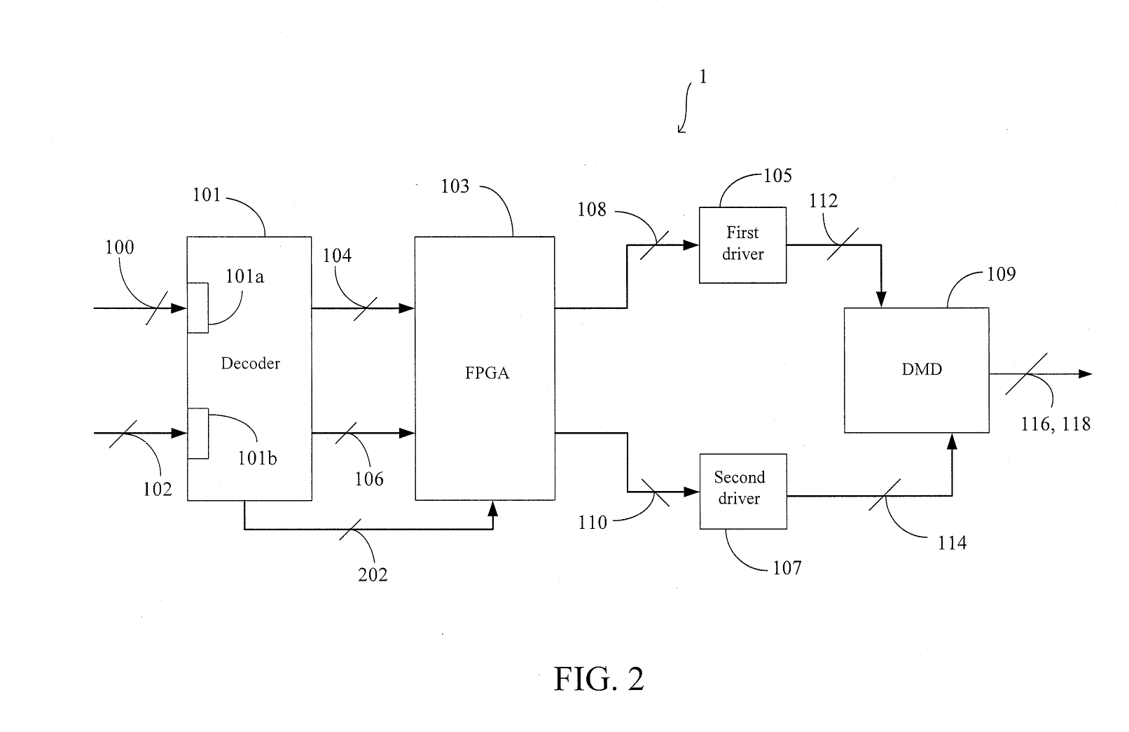

A third embodiment of the present invention is shown in FIG. 2. Different from the first embodiment and the second embodiment, the video processor 101 and the FPGA 103 in this embodiment further have another path therebetween for transmitting an on screen display (OSD) data 202.

Specifically, when a user desires to make the projection image of the projector show an OSD picture, the video processor 101 further generates the OSD data 202 apart from generating the left-eye signal 104 and the right-eye signal 106 according to the first video data 100 and the second video data 102 that are received. Then, the FPGA 103 receives the OSD data 202 via the another path, and embeds the OSD data 202 into the left-eye signal 104 and the right-eye signal 106. In this way, both of the left-eye image 116 and the right-eye image 118 projected by the DMD 109 can show the OSD picture corresponding to the OSD data 202.

According to the above descriptions, the dual-channel projector of the present invention uses two input interfaces to receive the video data and utilizes a dual-channel signal processing mechanism to project a left-eye image and a right-eye image of a high resolution at a high image refresh rate. Taking an HDMI format signal as an example, the present invention can enable the DMD 109 to alternately project the left-eye image 116 and the right-eye image 118 of a resolution of 1080 p at an image refresh rate of 120 images per second. Thereby, the present invention can overcome the problem of the conventional single-input projector that it has a low resolution or a low image refresh rate.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A dual-channel three-dimension projector, comprising:
a video processor, having a first input interface configured to receive a first video data and a second input interface configured to receive a second video data, and being configured to decode the first video data and the second video data to generate a left-eye signal and a right-eye signal;
a field-programmable gate array (FPGA), being configured to receive the left-eye signal and the right-eye signal from the video processor via two paths respectively, and generate a left-image signal and a right-image signal according to the left-eye signal and the right-eye signal;
a first driver, being electrically connected to the FPGA, and configured to receive the left-image signal to generate a left-image control signal;
a second driver, being electrically connected to the FPGA, and configured to receive the right-image signal to generate a right-image control signal; and
a digital micromirror device (DMD), being electrically connected to the first driver and the second driver, and configured to alternately project a left-eye image and a right-eye image according to the left-image control signal and the right-image control signal.

2. The dual-channel three-dimension projector as claimed in claim 1, wherein the first video data is a left-eye video data, and the second video data is a right-eye video data.

3. The dual-channel three-dimension projector as claimed in claim 2, wherein the left-eye video data has a data quantity with a resolution of 1080 p and with 60 frames per second of the left-eye image, and the right-eye video data has a data quantity with a resolution of 1080 p and with 60 frames per second of the right-eye image.

4. The dual-channel three-dimension projector as claimed in claim 1, wherein the first video data and the second video data are identical, and have a left-eye video data and a right-eye video data.

5. The dual-channel three-dimension projector as claimed in claim 4, wherein the first video data and the second video data have a data quantity with a resolution of half of 1080 p and with 60 frames per second of the left-eye image and the right-eye image.

6. The dual-channel three-dimension projector as claimed in claim 5, wherein the video processor is further configured to separate the left-eye video data and the right-eye video data, interpolate the left-eye video data and the right-eye video data to the resolution of 1080 p respectively, generate the left-eye signal according to the interpolated left-eye video data, and generate the right-eye signal according to the interpolated right-eye video data.

7. The dual-channel three-dimension projector as claimed in claim 1, wherein the first input interface and the second input interface are a high definition multimedia interface (HDMI).

8. The dual-channel three-dimension projector as claimed in claim 1, wherein the video processor further generates an on screen display (OSD) data, and transmits the OSD data to the FPGA via another path, and the FPGA further embeds the OSD data in the left-eye signal and the right-eye signal to make both of the left-eye image and the right-eye image show an OSD picture.
